(19) United States
(12) Patent Application Publication
(10) Pub. No.: US 2011/0272389 A1
(43) Pub. Date: Nov. 10, 2011

(54) HEATING AND FLUIDIZATION SYSTEM FOR AIR FLUIDIZED SAND BEDS

(76) Inventor: Thomas W. Tyl, Siler City, NC (US)

(21) Appl. No.: 12/777,245

(22) Filed: May 10, 2010

(51) Int. Cl. H05B 3/00

(52) U.S. Cl. 219/201

(57) ABSTRACT

A heating and fluidization system for air fluidized sand beds, and associated methods, are disclosed. Control of a heat input is separated from control of a fluidization rate to optimize simultaneously both the amount of heat entering the system and the heat transfer rate. In at least one embodiment, the system includes: a heating tube configured to receive a heat input from a heat source and to provide the heat input to a media in a bed at a first predetermined, optimized rate; and a fluidization tube disposed, generally, below the heating tube and configured to provide a fluidization rate to the media in the bed at a second predetermined, optimized rate, thereby adapted to control fluidization and to maximize heat transfer. The heating tubes can include spines to increase surface area and maximize heat transfer. The fluidization holes can be covered by nozzles to direct the fluidization.

### FIELD OF THE INVENTION

The technology described herein relates generally to the fields of heat treating and air fluidized sand beds. More specifically, the technology relates to a heating and fluidization system for air fluidized sand beds and associated methods in which control of a heat input is separated from control of a fluidization rate to optimize simultaneously both the amount of heat entering the system and the heat transfer rate.

### BACKGROUND OF THE INVENTION

It is extremely difficult to maximize heat transfer in an air fluidized sand bed. Known air fluidized sand beds link the fluidization level and the amount of heat input. By way of example, known strand air fluidized sand beds, especially gas heated models, cannot disconnect heating from fluidization. When more heat is needed, burners fire harder and fluidization increases, generally lowering heat transfer rate. Some manufacturers are known to fire burners directly into fluidization tubes. However, such a process locks the system into running in a tight range as determined by the amount of material flowing through the system for heat treatment.

### BRIEF SUMMARY OF THE INVENTION

In various exemplary embodiments, the technology described herein provides for a heating and fluidization system for air fluidized sand beds and associated methods in which control of a heat input is separated from control of a fluidization rate to optimize simultaneously both the amount of heat entering the system and the heat transfer rate.

In one exemplary embodiment, the technology described herein provides a heating and fluidization tube for air fluidized sand beds. The tube includes: a tube having a circumferential side wall and adapted for use in an air fluidized sand bed, configured to receive a heat input from a heat source, and to provide the heat input to a media in the bed at a first predetermined, optimized rate; and a plurality of fluidization holes disposed on the circumferential side wall of the tube through which a fluidization gas departs at a second predetermined, optimized rate to maximize a fluidization level of the bed to maximize a heat transfer rate. The control of the heat input is separated from control of the fluidization rate to optimize simultaneously both the amount of heat entering the system and the heat transfer rate.

In at least one embodiment of the tube, the heat source is an electrical heating element disposed with the tube and through which the fluidization gas is introduced.

In at least one embodiment of the tube, the heat source is a gas heating system having a gas-fired burner and a mixing system having a combustible mixture of gasses.

In at least one embodiment of the tube, at least one spine is disposed upon the tube and adapted to increase surface area of the tube and thereby to increase heat transfer.

In at least one embodiment of the tube, at least one nozzle is disposed upon the tube, adapted to cover one fluidization hole, and adapted to increase air flow around the tube.

In another exemplary embodiment, the technology described herein provides a heating and fluidization system for air fluidized sand beds. The system includes: a heating tube configured to receive a heat input from a heat source and to provide the heat input to a media in a bed at a first predetermined, optimized rate; and a fluidization tube disposed, generally, below the heating tube and configured to provide a fluidization rate to the media in the bed at a second predetermined, optimized rate, thereby adapted to control fluidization and to maximize heat transfer. The control of the heat input is separated from control of the fluidization rate to optimize simultaneously both the amount of heat entering the system and the heat transfer rate.

In at least one embodiment of the system, a plurality of holes are disposed within a circumferential side wall of the heating tube, the holes adapted for passage through which a gas at a level optimized for heat transfer can escape.

In at least one embodiment of the system, a plurality of holes are disposed within a circumferential side wall of the heating tube and adapted for passage through which a gas at a pressure and a velocity below an optimal fluidization level for heat transfer can escape.

In at least one embodiment of the system, a plurality of fluidization holes disposed within a circumferential side wall of the fluidization tube and adapted to disperse fluidization gas into the system.

In at least one embodiment of the system, the heat source includes an electrical heating element disposed with the heating tube.

In at least one embodiment of the system, the heat source includes a gas heating system having a gas-fired burner and a mixing system for a combustible mixture of gasses.

In at least one embodiment of the system, at least one spine is disposed upon the heating tube and adapted to increase surface area of the heating tube and thereby to increase heat transfer.

In at least one embodiment of the system, at least one nozzle is disposed upon the fluidization tube, adapted to cover one fluidization hole, and adapted to increase air flow around the heating tube.

In at least one embodiment of the system, a plurality of heating tubes and a plurality of fluidization tubes are utilized. The plurality of heating tubes includes an upper row in the bed, and the plurality of fluidization tubes includes a lower row in the bed located directly below the row of heating tubes. Alternatively, the plurality of heating tubes includes an upper row in the bed, and the plurality of fluidization tubes includes a lower row in the bed located below the row of heating tubes in an offset pattern with no fluidization tube placed directly below a heating tube.

In yet another exemplary embodiment, the technology described herein provides a method for simultaneous, independent control of both heating and fluidization in a heating and fluidization system for air fluidized sand beds. The method includes: providing at least one heating tube configured to receive a heat input from a heat source and to provide the heat input to a media in a bed at a first predetermined, optimized rate; providing at least one fluidization tube disposed, generally, below the heating tube and configured to provide a fluidization rate to the media in the bed at a second predetermined, optimized rate, thereby adapted to maximize heat transfer; applying the heat input to the media in the bed at the first predetermined, optimized rate; controlling the fluidization at the second predetermined, optimized rate, thereby maximizing heat transfer; and separating control of the heat input from control of the fluidization rate for optimizing simultaneously both the amount of heat entering the system and the heat transfer rate.

The method also can include, wherein the heat source comprises an electrical heating element disposed with the tube: providing a plurality of holes disposed within a circumferential side wall of the heating tube, the holes adapted for passage through which a gas at a level optimized for heat transfer can escape; maintaining, at the optimized level, the gas at a constant level to maximize heat transfer; providing a plurality of fluidization holes disposed within a circumferential side wall of the fluidization tube and adapted to disperse fluidization gas into the system; and maximizing heat transfer between the heating tube and the media.

The method also can include, wherein the heat source comprises a gas heating system having a gas-fired burner and a mixing system for a combustible mixture of gasses: providing a plurality of holes disposed within a circumferential side wall of the heating tube and adapted for passage through which a gas at a pressure and a velocity below an optimal fluidization level for heat transfer can escape; setting the pressure and velocity of the combustion gasses and combustion products to a level below the optimal fluidization level; providing a plurality of fluidization holes disposed within a circumferential side wall of the fluidization tube and adapted to disperse fluidization gas into the system; and maximizing heat transfer between the heating tube and the media.

The method further can include: utilizing a plurality of spines on the heating tube adapted to increase surface area of the heating tube and thereby to increase heat transfer; and utilizing a plurality of nozzles on the fluidization tube upon the fluidization holes to increase air flow around the heating tube.

The method further can include: utilizing a plurality of heating tubes; utilizing a plurality of fluidization tubes; and placing the plurality of fluidization tubes below the plurality of heating tubes in a predetermined pattern selected to optimize heat transfer.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a side cross-sectional view of a heating and fluidization system for air fluidized sand bands, illustrating, in particular, the upper heating pipes, in line and without spines, according to an embodiment of the technology described herein;

FIG. 2 is a side cross-sectional view of a heating and fluidization system for air fluidized sand bands, illustrating, in particular, the upper heating pipes, in line and with spines, according to an embodiment of the technology described herein;

FIG. 3 is a side cross-sectional view of a heating and fluidization system for air fluidized sand bands, illustrating, in particular, the upper heating pipes and the lower fluidization pipes, in line and without spines, according to an embodiment of the technology described herein;

FIG. 4 is a side cross-sectional view of a heating and fluidization system for air fluidized sand bands, illustrating, in particular, the upper heating pipes and the lower fluidization pipes, in line and with spines, according to an embodiment of the technology described herein;

FIG. 5 is a side cross-sectional view of a heating and fluidization system for air fluidized sand bands, illustrating, in particular, the upper heating pipes and the lower fluidization pipes, staggered and without spines, according to an embodiment of the technology described herein; and

FIG. 6 is a side cross-sectional view of a heating and fluidization system for air fluidized sand bands, illustrating, in particular, the upper heating pipes and the lower fluidization pipes, staggered and with spines, according to an embodiment of the technology described herein.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides for a heating and fluidization system for air fluidized sand beds and associated methods in which control of a heat input is separated from control of a fluidization rate to optimize simultaneously both the amount of heat entering the system and the heat transfer rate.

The driving force for heat treating is the difference in temperature between the material and the media. However, the rate of heat transfer in a fluidized bed is greatly influenced by the rate of fluidization of the sand (or media). If there is too much air in the sand heat transfer is low because heat transfer from a gas to a solid is slow. If there is too much sand in the air/sand mixture heat transfer is slow because sand circulation in the fluidized bed does not allow sand to pick up heat from the heating tubes; pockets of cold sand surround the wire.

The technology described herein provides a method to control fluidization pressure and volume to maximize heat transfer and a method to apply heat to the sand (media) at an optimum rate separately. Utilizing a top set of tubes to provide heat and a bottom set of tubes to provide fluidization at an optimum level maximizes heat transfer from the heating tubes to the sand and from the sand to the wire. The ability to “point” fluidization via fluidization nozzles causes air and sand to sweep across the heated tubes ensuring maximum heat transfer.

The technology described herein can be implemented in several embodiments. The technology includes a tube (pipe) or combination of several tubes (pipes), which when surrounded by sand or similar media in a gas fluidized sand bed allows for controlled heating (or cooling) and controlled fluidization simultaneously.

The core components of the technology are: (1) a tube or pipe containing an electrical heating element through which a fluidization gas is introduced, exiting the tube or pipe through fluidization holes or nozzles located in various positions on the tube or pipe; or (2) a tube or pipe with a gas-fired burner and mixing system containing a combustible mixture of gasses exiting the tube or pipe through fluidization holes or nozzles located in various positions on the tube or pipe; or (3) a combination of tubes or pipes some containing an electrical heating element through which a fluidization gas is introduced, exiting the tube or pipe through fluidization holes or nozzles located in various positions on the tube or pipe; or (4) a combination of tubes or pipes with a gas-fired burner and mixing system containing a combustible mixture of gasses exiting the tube or pipe through fluidization holes or nozzles located in various positions on the tube or pipe and additional tubes or pipes into which a gas is introduced and exit through fluidization holes or nozzles located in various positions on the tube or pipe. These, generally speaking, are configured as follows: {see drawings}. The invention can be used to control separately the heat input into a fluidized bed and the amount of fluidization in a fluidized bed. So, regardless of the heat input required the fluidization level can be maintained at a steady rate to maximize heat transfer from the heat source to the sand. Furthermore, it should be noted that since the fluidization level is held at a rate to maximize heat transfer from the heat source to the sand, the rate of heat transfer from the sand to the product is also maximized.

As stated in regard to systems known in the background art, it is extremely difficult to maximize heat transfer is a fluidized bed because most, if not all, fluidized beds link the fluidization level and the amount of heat input. Utilizing the technology described herein, when electrical elements are used for a heat source, the fluidization gas enters the tube or pipe containing the electrical heating element and is held at a constant level that maximizes heat transfer. The amount of heat can be varied by changing the amount of current flowing through electrical elements without affecting the fluidization rate. In the new design, when a gas heating system is used for a heat source the pressure and flow rate of the combustion gasses and combustion products are set to a level well below the optimal fluidization level. There are holes or nozzles in the burner pipes to allow the combustion products to escape into the fluidized sand. The gas fired burner pipes are located above a second set of pipes that control fluidization level. The fluidization gas enters the second set of tubes or pipes and is held at a constant level that maximizes heat transfer and sweeps over the heated pipes above them to help transfer heat from the heat source to the sand. The amount of heat can be varied by changing the burner pressure to a level still below the optimum fluidization level without affecting the optimum fluidization rate.

For an electrical application at least one fluidization pipe or tube containing electrical elements is utilized. The pipe has several holes or nozzles around the circumference through which fluidization gas at a level optimized for heat transfer can escape.

For a gas application at least one fluidization pipe or tube containing heat energy from burning gasses is utilized. The pipe has several holes or nozzles around the circumference through which combustion gasses can escape and the pressure and velocity of these gasses are well below the optimal fluidization level for heat transfer. Below this pipe is located at least one fluidization pipe through which fluidization gas enters the system at a level optimal for heat transfer. These gasses sweep over the heated tube or pipe above and help maximize the heat transfer between the hot pipe surface and the sand.

Heated tubes can contain spines to help increase surface area and thus heat transfer. The spines are metal rounds welded to the heated tube. Fluidization tubes can contain nozzles made of tubes that are welded over the holes in the fluidization tube. The nozzles can be designed to increase the flow of air over the heated tubes above increasing heat transfer.

For an electric application the most complete version of this technology includes two rows of pipes or tubes all containing electric heating elements and fluidization nozzles. The two rows of pipes are offset in a horizontal plane so that the bottom row of fluidization/heating pipes lies in the gap between the upper row of pipes. All of the pipes have spines to improve heat transfer and nozzles to help direct fluidization.

For a gas fired application the most complete version of the technology includes two rows of pipes or tubes the top row containing gas heating elements and heat transfer spines in addition to a row of holes in the bottom of the pipe for the escape of exhaust gasses. The two rows of pipes are offset in a horizontal plane so that the bottom row of fluidization pipes lies in the gap between the upper row of pipes. All of the pipes lower pipes have fluidization tubes (nozzles) to help direct fluidization.

Referring now to the Figures, several systems are illustrated. It will be apparent to one of ordinary skill in the art, upon reading this disclosure, that varied embodiments can provide alternative systems.

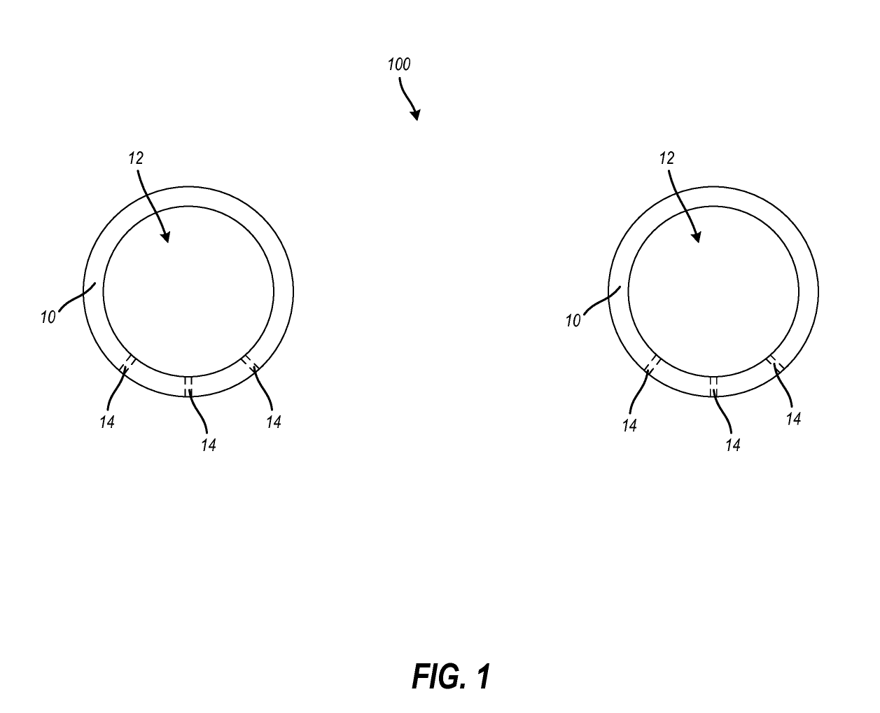

System 100 is depicted in FIG. 1. System 100 illustrates the upper heating tubes 10, in line and without spines and nozzles. The tube 10 has a circumferential side wall and hollow cavity 12. The tube is adapted for use in an air fluidized sand bed. The tube 10 is configured to receive a heat input from a heat source, and to provide the heat input to a media in the bed. Each tube includes fluidization holes 14 disposed on the circumferential side wall of the tube 10. A fluidization gas departs through the fluidization holes 14.

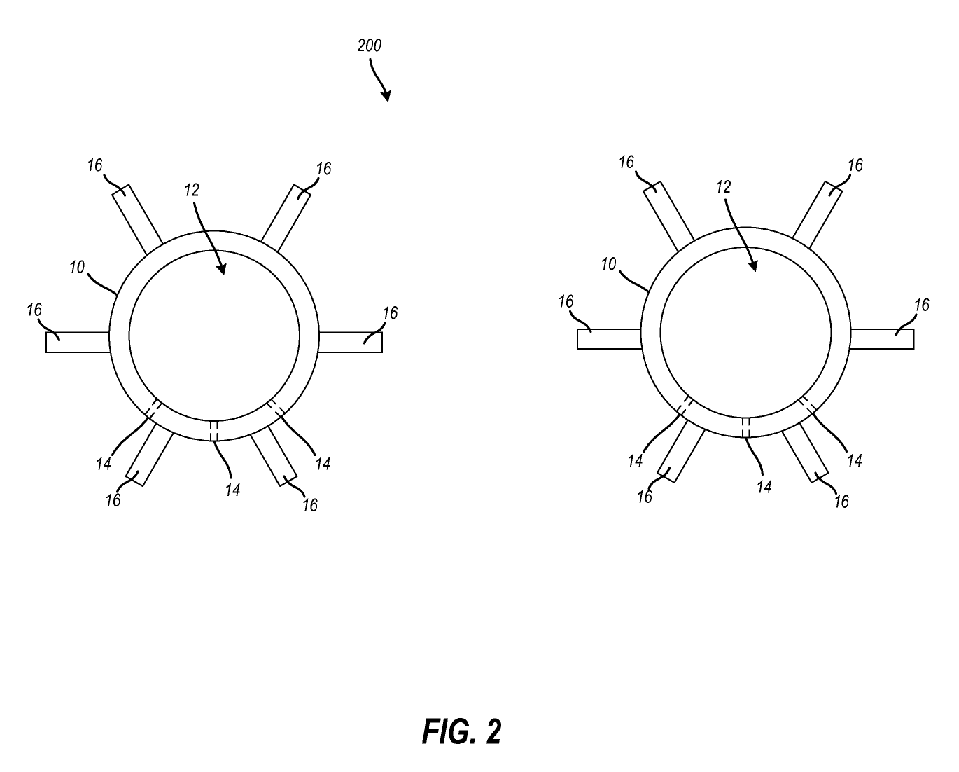

System 200 shown in FIG. 2 illustrates the elements depicted in FIG. 1, and additionally illustrates the use of multiple spines 16 on a heating tube 10. As depicted the spines 16 do not cover any of the holes 14, such that the release of exhaust gasses can still occur. The spines 16 help increase surface area of the tube 10 and thus improve heat transfer. In at least one embodiment, the spines 16 are metal rounds welded to the heated tube 10.

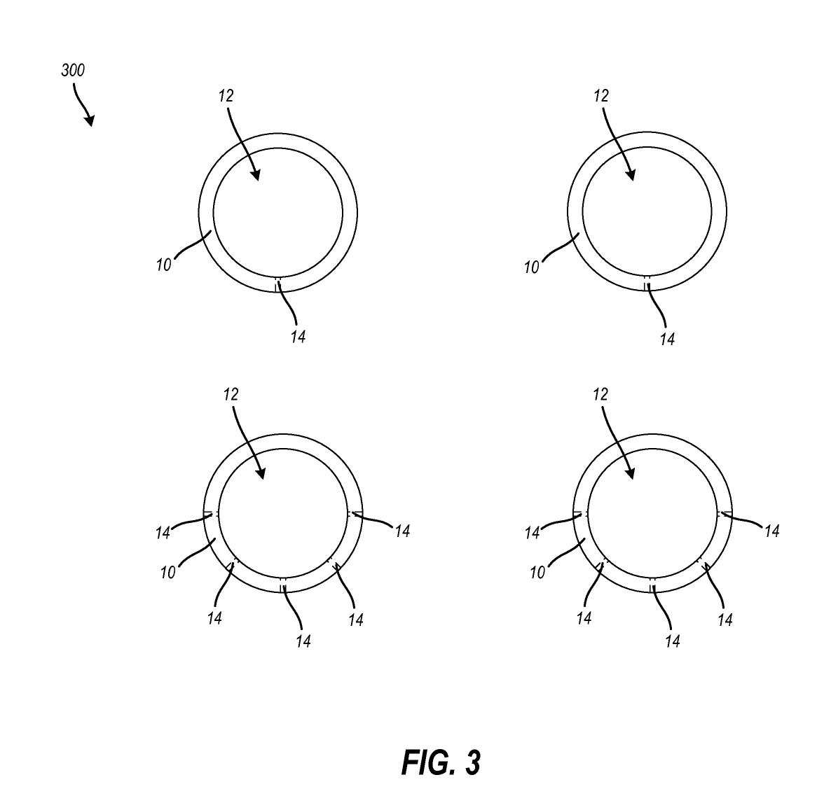

System 300 shown in FIG. 3 illustrates multiple tubes 10 in line and without spines and nozzles. The upper row includes heating tubes and the lower row includes fluidization tubes. In the configuration shown, each fluidization tube in the lower row is placed directly below a heating tube of the upper row in the bed to maximize heat transfer.

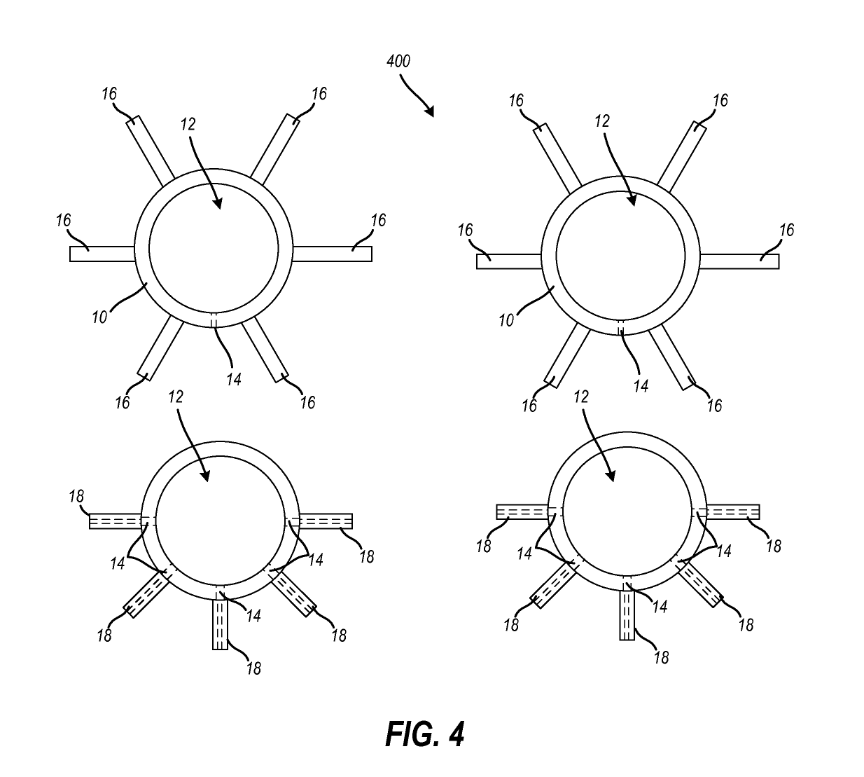

System 400 shown in FIG. 4 illustrates multiple tubes 10 in line and with spines and nozzles. The upper row includes heating tubes and the lower row includes fluidization tubes. The heating tubes contain spines 16 to increase surface area and improve heat transfer. The fluidization tubes include nozzles 18 to cover each fluidization hole 14 and essentially point and direct the flow and path of fluidization gas and to maximize heat transfer.

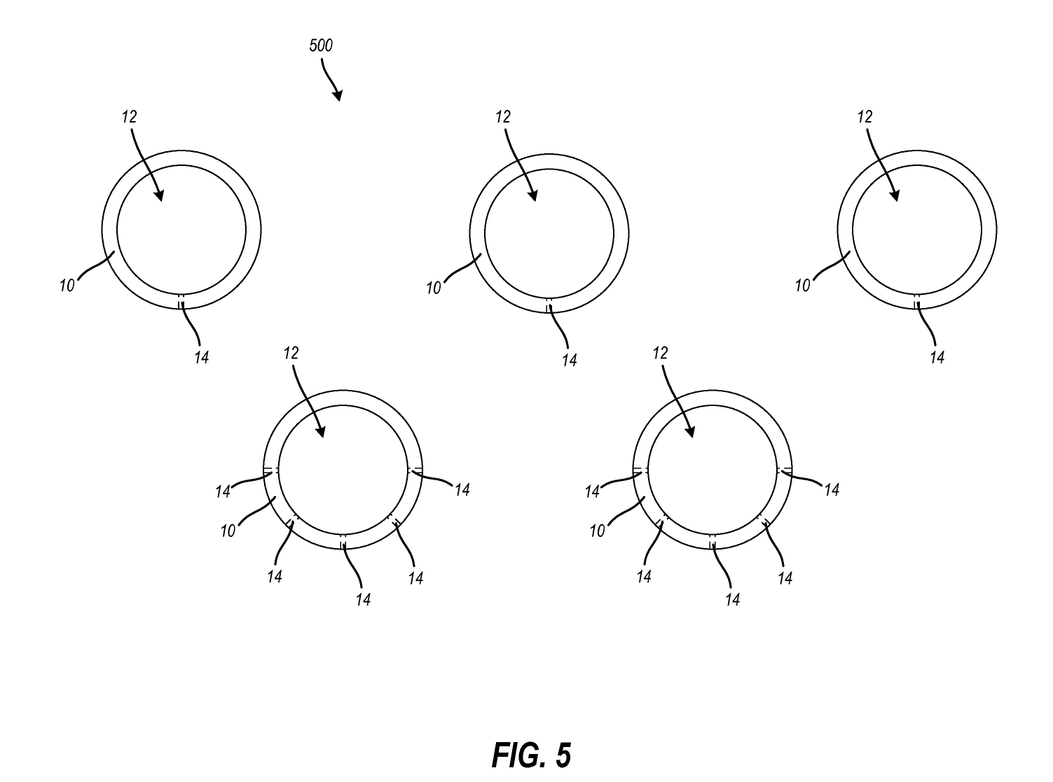

System 500 shown in FIG. 5 illustrates multiple tubes 10 staggered, or offset, and without spines and nozzles. As depicted, the upper row includes heating tubes, and the lower row includes fluidization tubes. In the configuration shown, each fluidization tube in the lower row is placed below a heating tube of the upper row in the bed, yet in a staggered, or offset, manner to maximize heat transfer.

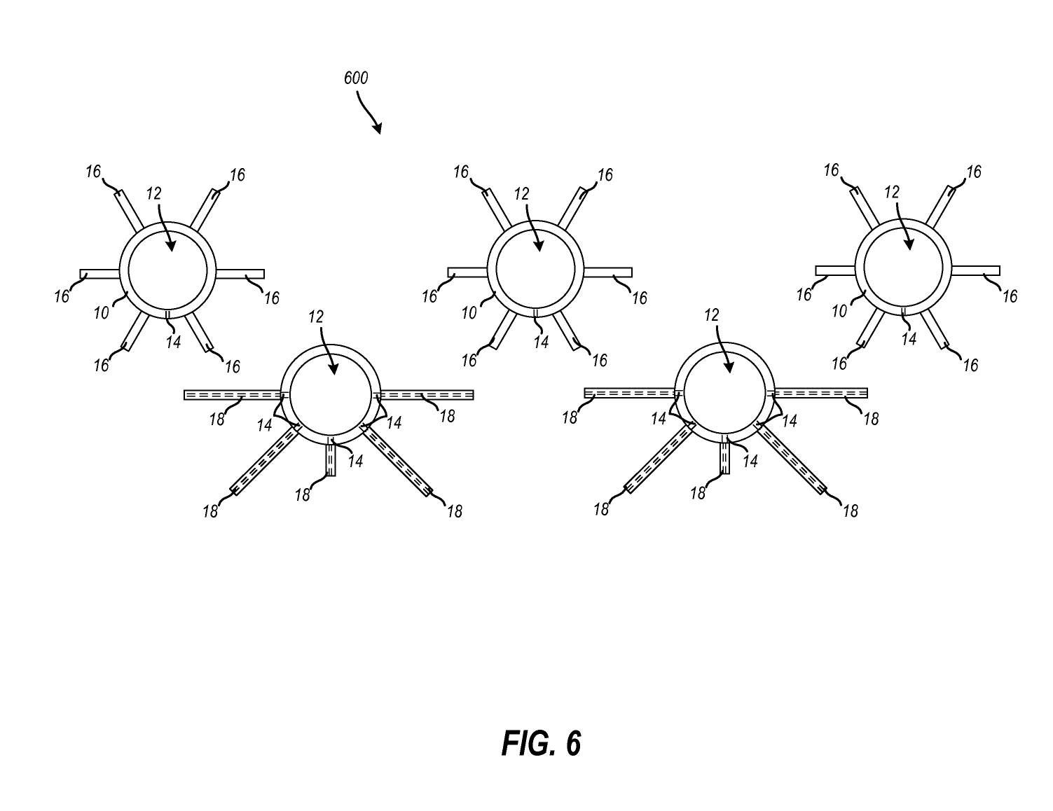

System 600 in FIG. 6 illustrates multiple tubes 10 staggered and with spines 16 and nozzles 18. The upper row includes heating tubes, and the lower row includes fluidization tubes. The heating tubes contain spines 16 to increase surface area and improve heat transfer. The fluidization tubes include nozzles 18 to cover each fluidization hole 14 and to point and direct the flow and path of fluidization gas. Each fluidization tube in the lower row is placed below a heating tube of the upper row in the bed, yet in a staggered, or offset, manner to maximize heat transfer.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosed technology and are intended to be covered by the following claims.

What is claimed is:

1. A heating and fluidization tube for air fluidized sand beds, the tube comprising:
a tube having a circumferential side wall and adapted for use in an air fluidized sand bed, configured to receive a heat input from a heat source, and to provide the heat input to a media in the bed at a first predetermined, optimized rate; and
a plurality of fluidization holes disposed on the circumferential side wall of the tube through which a fluidization gas departs at a second predetermined, optimized rate to maximize a fluidization level of the bed to maximize a heat transfer rate;
wherein the control of the heat input is separated from control of the fluidization rate to optimize simultaneously both the amount of heat entering the system and the heat transfer rate.

2. The heating and fluidization tube of claim 1, wherein the heat source comprises an electrical heating element disposed with the tube and through which the fluidization gas is introduced.

3. The heating and fluidization tube of claim 1, wherein the heat source comprises a gas heating system having a gas-fired burner and a mixing system having a combustible mixture of gasses.

4. The heating and fluidization tube of claim 1, further comprising:
at least one spine disposed upon the tube and adapted to increase surface area of the tube and thereby to increase heat transfer.

5. The heating and fluidization tube of claim 1, further comprising:
at least one nozzle disposed upon the tube, adapted to cover one fluidization hole, and adapted to increase air flow around the tube.

6. A heating and fluidization system for air fluidized sand beds, the system comprising:
a heating tube configured to receive a heat input from a heat source and to provide the heat input to a media in a bed at a first predetermined, optimized rate; and
a fluidization tube disposed, generally, below the heating tube and configured to provide a fluidization rate to the media in the bed at a second predetermined, optimized rate, thereby adapted to control fluidization and to maximize heat transfer; and
wherein the control of the heat input is separated from control of the fluidization rate to optimize simultaneously both the amount of heat entering the system and the heat transfer rate.

7. The system of claim 6, further comprising:
a plurality of holes disposed within a circumferential side wall of the heating tube, the holes adapted for passage through which a gas at a level optimized for heat transfer can escape.

8. The system of claim 6, further comprising:
a plurality of holes disposed within a circumferential side wall of the heating tube and adapted for passage through which a gas at a pressure and a velocity below an optimal fluidization level for heat transfer can escape.

9. The system of claim 6, further comprising:
a plurality of fluidization holes disposed within a circumferential side wall of the fluidization tube and adapted to disperse fluidization gas into the system.

10. The system of claim 6, wherein the heat source comprises an electrical heating element disposed with the heating tube.

11. The system of claim 6, wherein the heat source comprises a gas heating system having a gas-fired burner and a mixing system for a combustible mixture of gasses.

12. The system of claim 6, further comprising:
at least one spine disposed upon the heating tube and adapted to increase surface area of the heating tube and thereby to increase heat transfer.

13. The system of claim 6, further comprising:
at least one nozzle disposed upon the fluidization tube, adapted to cover one fluidization hole, and adapted to increase air flow around the heating tube.

14. The system of claim 6, further comprising:
a plurality of heating tubes; and
a plurality of fluidization tubes;
wherein the plurality of heating tubes comprises an upper row in the bed, and the plurality of fluidization tubes comprises a lower row in the bed located directly below the row of heating tubes.

15. The system of claim 6, further comprising:
a plurality of heating tubes; and
a plurality of fluidization tubes;
wherein the plurality of heating tubes comprises an upper row in the bed, and the plurality of fluidization tubes comprises a lower row in the bed located below the row of heating tubes in an offset pattern with no fluidization tube placed directly below a heating tube.

16. A method for simultaneous, independent control of both heating and fluidization in a heating and fluidization system for air fluidized sand beds, the method comprising:
providing at least one heating tube configured to receive a heat input from a heat source and to provide the heat input to a media in a bed at a first predetermined, optimized rate;
providing at least one fluidization tube disposed, generally, below the heating tube and configured to provide a fluidization rate to the media in the bed at a second predetermined, optimized rate, thereby adapted to maximize heat transfer;
applying the heat input to the media in the bed at the first predetermined, optimized rate;
controlling the fluidization at the second predetermined, optimized rate, thereby maximizing heat transfer; and
separating control of the heat input from control of the fluidization rate for optimizing simultaneously both the amount of heat entering the system and the heat transfer rate.

17. The method of claim 16, wherein the heat source comprises an electrical heating element disposed with the tube, the method further comprising:
providing a plurality of holes disposed within a circumferential side wall of the heating tube, the holes adapted for passage through which a gas at a level optimized for heat transfer can escape;
maintaining, at the optimized level, the gas at a constant level to maximize heat transfer;
providing a plurality of fluidization holes disposed within a circumferential side wall of the fluidization tube and adapted to disperse fluidization gas into the system; and
maximizing heat transfer between the heating tube and the media.

18. The method of claim 16, wherein the heat source comprises a gas heating system having a gas-fired burner and a mixing system for a combustible mixture of gasses, the method further comprising:
providing a plurality of holes disposed within a circumferential side wall of the heating tube and adapted for passage through which a gas at a pressure and a velocity below an optimal fluidization level for heat transfer can escape;
setting the pressure and velocity of the combustion gasses and combustion products to a level below the optimal fluidization level;
providing a plurality of fluidization holes disposed within a circumferential side wall of the fluidization tube and adapted to disperse fluidization gas into the system; and
maximizing heat transfer between the heating tube and the media.

19. The method of claim 16, further comprising:
utilizing a plurality of spines on the heating tube adapted to increase surface area of the heating tube and thereby to increase heat transfer; and
utilizing a plurality of nozzles on the fluidization tube upon the fluidization holes to increase air flow around the heating tube.

20. The method of claim 16, further comprising:
utilizing a plurality of heating tubes;
utilizing a plurality of fluidization tubes; and
placing the plurality of fluidization tubes below the plurality of heating tubes in a predetermined pattern selected to optimize heat transfer.
